(19) United States
(12) Patent Application Publication
(10) Pub. No.: US 2018/0122263 A9
(43) Pub. Date: May 3, 2018

(54) CREATING A WORKOUT ROUTINE IN ONLINE AND MOBILE NETWORKING ENVIRONMENTS

(71) Applicant: GlobalMe, LLC, Windermere, FL (US)

(72) Inventors: Anne Shrake, Windermere, FL (US); Aaron Mapes, Prineville, OR (US)

(21) Appl. No.: 14/242,553

(22) Filed: Apr. 1, 2014

Related U.S. Application Data
(63) Continuation-in-part of application No. 14/067,624, filed on Oct. 30, 2013, now Pat. No. 9,799,230.
(60) Provisional application No. 61/710,194, filed on Oct. 5, 2012.

(51) Int. Cl. G09B 19/00; G09B 7/00

(52) U.S. Cl. CPC G09B 19/0092; G09B 7/00; G09B 19/0038

(57) ABSTRACT

Methods and systems for creating workout routines are provided. An example method includes dynamically receiving data associated with one or more user personal metrics. The method further includes providing a user with a plurality of workout video segments based on the data associated with user personal metrics. The method also includes receiving, from the user, a video selection. The video selection includes one or more workout video segments selected from the plurality of workout video segments. The method further includes determining that the user personal metrics differ from predetermined user personal metrics. Based on the determination, the workout video segments are dynamically customized to obtain one or more customized video segments. The method further includes dynamically overlaying the data associated with the personal metrics over the customized video segments. After overlaying the data, one or more output customized video segments are obtained and displayed to the user.

### CROSS-REFERENCE TO RELATED APPLICATIONS

This patent is a Continuation-in-Part of U.S. patent application Ser. No. 14/067,624, titled “Creating Workout Routine and Nutritional Choices in an Online Environment,” filed Oct. 30, 2013, the disclosure of which is incorporated herein by reference.

### TECHNICAL FIELD

This application relates generally to data processing and, more specifically, to generating a dynamic feedback in a media stream of a workout routine in online and mobile networking environments.

### BACKGROUND

Health and medical experts stress the importance of exercising on a regular basis to in order to maintain a healthy lifestyle. Virtually every town has some type of a gym or health club facility that offers a multitude of in-person health and fitness programs.

Despite the availability of these facilities, there are many reasons why an individual would rather exercise in a private setting, such as home or office, for example. Several of the most common reasons include: a commute to or from a gym, financial obligations resulting from high membership and activity fees, fear of other gym members, and the requirement to conform to a rigorous and impersonal routine when attending a gym class, which is designed to be a “one size fits all” approach.

For each of these reasons, home gyms have become increasingly popular in recent years. Whether using home fitness machines or performing various cardiovascular activities that do not require fitness machines, home exercise can suffer from several drawbacks. For example, at home, an individual needs to be self-motivated and capable of creating a plurality of different workout routines to obtain good results. Moreover, individuals exercising at home do not have access to a skilled personal trainer who can provide custom instructions and motivation to the individuals who are looking to achieve a specific goal.

Additionally, current workout videos and audio multimedia files cannot provide an individual with any feedback as to the effectiveness of a workout. In particular, an individual has no way of determining how his/her body is responding to the workout. A heart rate is known to be the most effective, accurate, and objective means of measuring such response. There is a variety of wearable devices on the market, such as watches or sensors, which display heart rate data. However, an individual needs to constantly monitor his/her watch or sensors to see the feedback (i.e., heart rate), while no feedback is obtained directly from the video and audio multimedia that the individual is watching.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a method for creating a workout routine. In certain embodiments, the method can include dynamically receiving data associated with one or more user personal metrics. The method can further include providing a user with a plurality of workout video segments based on the data associated with one or more personal metrics of the user. The method can continue with receiving, from the user, a video selection. The video selection can include one or more workout video segments selected from the plurality of workout video segments. The method can further include determining that the user's personal metrics differ from predetermined user personal metrics. Based on the determining, the one or more workout video segments can be dynamically customized to obtain one or more customized video segments. The method can further include dynamically overlaying the data associated with the one or more user personal metrics over the one or more customized video segments. After the overlaying, one or more output customized video segments can be obtained and provided to the user.

Additionally provided is a system for creating a workout routine. In certain embodiments, the system includes a processor and a database comprising computer-readable instructions for execution by the processor. The processor can be configured to dynamically receive data associated with one or more user personal metrics and provide the user with a plurality of workout video segments based on the user personal metrics. The processor can be further configured to receive, from the user, a video selection. The video selection can include one or more workout video segments selected from the plurality of workout video segments. The processor can be configured to determine that the one or more user personal metrics differ from predetermined user personal metrics. Based on the determining, the processor can be configured to dynamically customize the one or more workout video segments to obtain one or more customized video segments. The processor can be further configured to dynamically overlay the data associated with the one or more user personal metrics over the one or more customized video segments. Therefore, one or more output customized video segments can be obtained. The processor can be further configured to provide the one or more output customized video segments to the user.

Provided also is a machine-readable medium including instructions, which when implemented by one or more processors, perform the following example operations. In one example operation, data associated with one or more user personal metrics are received from a user. In a further example operation, a user is provided with a plurality of workout video segments based on the data associated with the one or more user personal metrics. In another example operation, a video selection is received from the user. The video selection can include one or more workout video segments selected from the plurality of workout video segments. In yet another operation, it can be determined that the one or more user personal metrics differ from predetermined user personal metrics. In yet another operation, the one or more workout video segments can be dynamically customized to obtain one or more customized video segments. In a further operation, the data associated with the one or more user personal metrics can be dynamically overlaid over the one or more customized video segments to obtain one or more output customized video segments. In yet another operation, the one or more output customized video segments are provided to the user.

The following detailed description together with the accompanying drawings will provide a better understanding of the nature and advantages of the present technology.

### BRIEF DESCRIPTION OF DRAWINGS

Embodiments are illustrated by way of example and not limitation in the figures of the accompanying drawings, in which like references indicate similar elements.

FIG. 1 shows a block diagram illustrating an example environment within which methods and systems for creating a workout routine can be implemented.

FIG. 2 is a flow chart illustrating a method for creating a workout routine.

FIG. 3 is block diagram of a system for creating a workout routine.

FIG. 4 is a screenshot of a user interface with a user dashboard page.

FIG. 5 is a screenshot of a user interface showing a user workout page.

FIG. 6 is a screenshot of a user interface showing a user customized workout page.

FIG. 7 is a screenshot of a user interface showing a nutritional choice page.

FIG. 8 is screenshot of a user interface showing a message center.

FIG. 9 shows a diagrammatic representation of an example machine in the form of a computer system within which a set of instructions for causing the machine to perform any one or more of the methodologies discussed herein is executed.

### DETAILED DESCRIPTION

In the following description, numerous specific details are set forth in order to provide a thorough understanding of the presented concepts. It should be understood, however, that the presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In accordance with various embodiments and the corresponding disclosure thereof, computer-implemented methods and systems for creating a workout routine in online and mobile environments are provided. The described methods and systems provide a unique way to experience a live interactive workout with a professional trainer in the privacy of the user's home.

Additionally provided are methods and systems for receiving feedback from wearable monitoring devices worn by a user during the work out. The received feedback is processed and integrated into the video and audio media presented to the user during the workout. The wearable monitoring devices can include heart rate monitors, activity trackers, biometric sensors, and so forth. The wearable monitoring devices can communicate with various types of electronic user devices including tablet Personal Computers (PCs), laptops, mobile and smart phones, computers, Television (TV)-sets, or any other electronic devices configured to display digital content and interact with remote servers via a network such as the Internet. In some example embodiments, the user devices merely embed a web browser to allow users to browse Internet websites and interact with a remote system for creating a user-defined workout routine in an online environment.

Thus, current physiological parameters of the user can be measured by one or more sensor. Information associated with the physiological parameters can be incorporated into the video stream by displaying the information over the video that the user is currently watching on the electronic user device. The information can include a heart rate, number of steps, number of calories, and other device readable data. Thus, based on the current physiological parameters of the user, visual feedback is provided so that the user can increase or decrease his or her intensity for a more effective workout.

Additionally, a typical video or an audio workout clip consists of one long stream. According to the system described herein, video or audio clips can be dynamically partitioned by dividing the clips into smaller incremental clips. Based on the physiological parameters of the user, specific incremental clips can be composed into another video or audio clip to help the user maintain an optimal workout zone. A video or audio clip can be paused, swapped, or tagged to create a more effective workout. Accordingly, the user can simply focus on the workout video or audio stream, while all required information is dynamically displayed to the user and the workout stream is tailored according to current physiological parameters of the user.

In some example embodiments, the wearable monitoring devices can communicate with head-worn displays for augmented reality, such as, for example, Google Glass. Therefore, a workout video including information associated with the physiological parameters of the user can be dynamically shown to the user on a head-worn display. In some further embodiments, the electronic user device can include virtual reality devices, such as, for example, virtual reality head-mounted displays. If this is the case, the workout videos, as well as information associated with the physiological parameters of the user and any other data related to the workout performance, can be dynamically shown to the user as a virtual three-dimensional environment.

Furthermore, the system described herein can record information measured via various sensors to a database to continue adapting and making recommendations for the user based on historical workout data. Additionally, users can design their own workouts from video or audio clips which can be predetermined, or operate as a “juke box” to serve up video clips that are most optimal for the workout goals of the user.

The system and method for creating a workout routine in online and mobile environments can be implemented in any number of different manners (for example, as a web-based remote application). In certain embodiments, the system and method described herein can be simultaneously implemented via different websites that are directed towards individual markets and/or geographic locales.

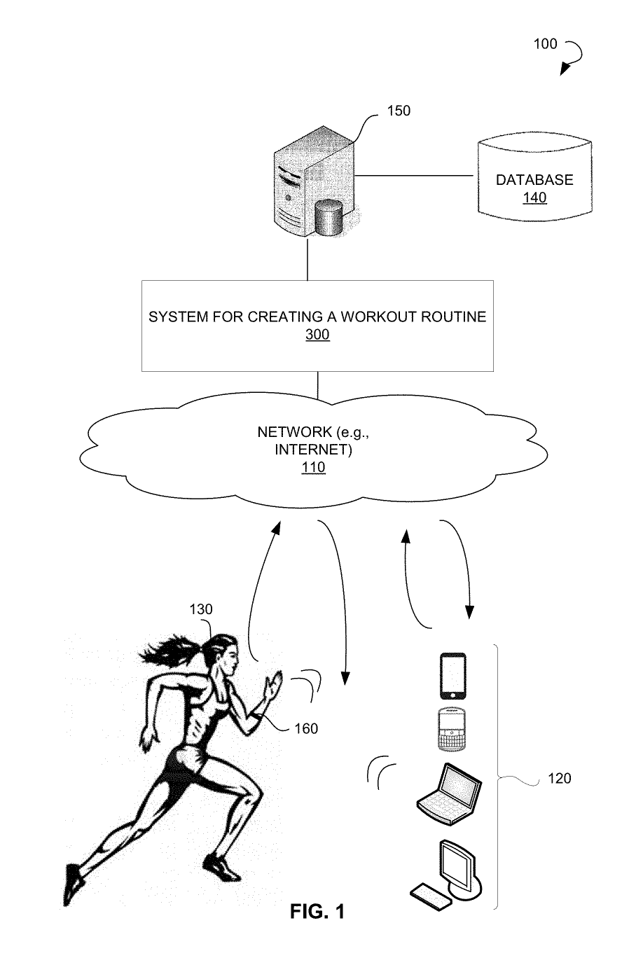

Referring now to the drawings, FIG. 1 is a block diagram showing an environment within which methods and systems for creating a workout routine may be implemented, according to an example embodiment. FIG. 1 shows an architecture 100 which includes a network 110, client devices 120, a user 130, a system 300 for creating a workout routine, a system database 140, a server 150, and a sensor 160. The user 130 communicates over the network 110 with the system 300 for creating a workout routine having one or more connected databases 140.

The network 110 includes the Internet or any other network capable of communicating data between devices. Suitable networks includes or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 includes a network of data processing nodes that are interconnected for the purpose of data communication.

The client devices 120, in some example embodiments, include a Graphical User Interface (GUI) for displaying a user system interface. The client devices 120 include a desktop computer, a laptop computer, a tablet computer, a cell phone, a smart phone, a gaming device, smart TVs, Roku, or the like. The user 130, in some example embodiments, includes persons interacting with the user system interface via the client devices 120. User 150 periodically interacts with the system 300 and provides or updates various data associated with the fitness, nutrition, and wellness status over time from any location (e.g., home computer and office computer). This information is retained in a system database 140.

The sensor 160 includes any digital device capable of measuring physiological parameters of the user 130, such as a heart rate monitor, a pedometer, an activity tracker, a biometric sensor, and so forth. The sensor 160 interacts with the client devices 120 via the network 110. In particular, the sensor 160 interacts with the client devices 120 via a bidirectional communication network, including wireless radio frequency (RF) communication that employs one or more of the following: Bluetooth, Wi-Fi, and Near Field Communication (NFC). Therefore, the client devices 120 receive biometric feedback from the sensor 160 during the workout of the user 150.

In certain embodiments, the system 300 connects to one or more servers 150, which are configured to host a website having format and information values stored within the database 140. The website displays a number of different screens for implementing the system 300 in online or mobile environments.

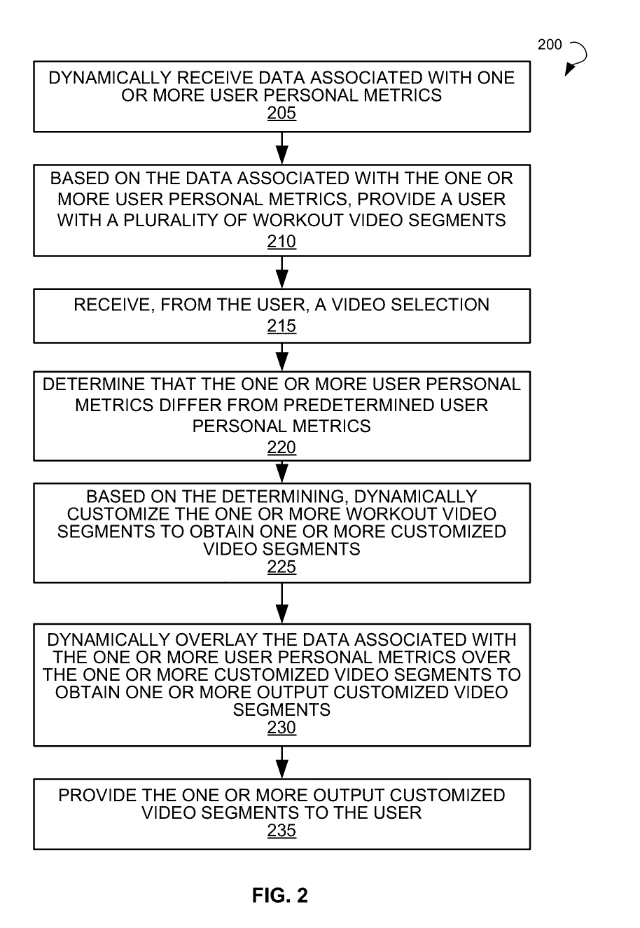

FIG. 2 shows a flow chart illustrating a method for creating a workout routine, in accordance with an example embodiment. The method 200 commences with dynamically receiving data associated with one or more user personal metrics at operation 205. In an example embodiment, the data associated with the one or more user personal metrics are received from one or more of a biometric sensor and a physiological sensor, including a heart rate tracker, a pedometer, an activity tracker, and the like. The user personal metrics include one or more of the following: a heart rate, a target heart rate, a maximum heart rate, a blood oxygen level, an oxygen consumption, calories burned, steps taken, distance covered, workout duration, workout intensity, a weight, a height, an age, a gender, a waist measurement, a fitness level, a cholesterol level, a blood pressure, a body mass index, and so forth. Some of the user personal metrics are measured by the sensors, while other user personal metrics can be calculated based on the measured user personal metrics. For example, calculation of calories burned can be based on heart rate intervals tracked throughout the workout.

At operation 210, upon receiving the data associated with one or more user personal metrics, the user is provided with a plurality of workout video segments based on the data associated with the one or more user personal metrics. The video segments include one or more exercises performed by one or more personal trainers. The personal trainer includes anyone with skill and knowledge in the area(s) of fitness, exercise, nutrition, diet, dietary supplements, weight loss, and/or healthy eating education. In certain embodiments, the plurality of workout video segments is provided as thumbnails to allow the user to preview exercises in each workout video segment. In further embodiments, the user is provided with one or more recommended workout video segments automatically compiled based on the user personal metrics.

In response to providing the plurality of workout video segments to the user, a video selection is received from the user at operation 215. The video selection includes one or more workout video segments selected from the plurality of workout video segments. In example embodiments, the workout video segments are divided into categories, such as target heart rate, intensity, body areas, and so forth, to enable the user to develop workout routines corresponding to fitness goals and personal preferences. Therefore, the user can select the suitable category and chose one or more workout video segments from the category.

The method 200 proceeds with determining that the one or more user personal metrics differ from predetermined user personal metrics at operation 220. At operation 225, the one or more workout video segments are dynamically customized based on the determined user personal metrics. Customization of the workout video segments includes selecting workout video segments that correspond to the changed one or more user personal metrics. The selected workout video segments are composed into a media file to obtain customized video segments. For example, the workout video segments are dynamically adjusted based on the target heart rate of the user and the current heart rate measured by a heart rate monitor.

In certain embodiments, one or more additional features, such as a warm up session, a recovery session, a stretching session, a meditation session, and the like, are incorporated into the customized video segments. Each workout video segment can be associated with a particular user personal metric. For example, specific workout video segments are selected for a warm-up zone, a target zone, and a maximum zone of the workout, where each zone is associated with a particular heart rate of the user. For example, the maximum zone associated with maximum heart rate can be calculated as ‘220 minus user age’. The heart rate for the target zone can constitute 60% to 85% of the maximum heart rate. In an example embodiment, the user or the personal trainer customizes the heart rate for each zone of the workout for better accuracy or according to the user goal. Furthermore, workout video segments can be customized within specific intervals, or instantaneously in real time, based on user performance, and continuously optimized to make sure that the user is maintaining the target heart rate.

Customization of the video segments also includes insertion of temporary recovery video segments of varying lengths depending on whether the user enters the transition between video segments in the maximum zone or the target zone of the workout. Alternatively, a recovery video segment is inserted based on pre-defined criteria, such as user is in the maximum zone for more than one minute during a target zone video segment. Furthermore, a video segment of the user workout can be automatically paused based on pre-defined criteria, such as the target zone has been maintained for a predetermined amount of time, or the user is at maximum heart rate or has gone above maximum heart.

Upon customization of the workout video segments, the method 200 proceeds with dynamically overlaying the data associated with the one or more user personal metrics over the one or more customized video segments at operation 230. Thus, one or more output customized video segments are obtained. In an example embodiment, the method 200 optionally comprises changing representation of the one or more output customized video segments. The representation is changed based on the determined user personal metrics. The changing includes one or more of color changing, size changing, animation, and so forth. For example, the color of a heart rate icon changes, with it being one color during warm-up, another color during target zone, and yet another color during maximum zone of the workout.

After obtaining the output customized video segments, the one or more output customized video segments are provided to the user at operation 235. For example, an actual heart rate is shown over the video segments. Alternatively, an icon associated with the heart rate is shown next to actual output heart rate. In an example embodiment, some metric data, such as an average maximum heart rate, are constantly shown on the output customized video segments.

The data overlaid over the customized video segments include estimated calories burned, goal time of working out in a target zone (based on length of the video segments), time of actual working out in the target zone out of available time in the target zone, and so forth. Such data can be translated into a percentage of effectiveness or score of performance. The percentage of effectiveness or score can be displayed to the user over the video segments in a form of a visual indicator, such as 3 stars, 4 stars, or 5 stars. Based on the goal of the user and measured user personal metrics, the best score is displayed to the user.

In an example embodiment, the method 200 further comprises providing an instruction to the user based on the data associated with the one or more user personal metrics. The instruction includes an indication to adjust (i.e., increase or decrease) the intensity of the workout routine. The instruction is one or more of a video instruction, an audio instruction, and a text instruction. The instruction can also be shown as a flash message or a popup box. The instruction is overlaid over the customized video segments. Therefore, the instruction is provided to the user along with the output customized video segments.

Optionally, the method 200 further comprises analyzing the workout routine of the user. The analysis is performed based on the data associated with the one or more user personal metrics. Based on the analysis, a plurality of recommended workout video segments is selected for a further workout routine.

In further optional embodiments, the method 200 comprises compiling one or more nutritional choices based on the data associated with the user personal metrics or based on goals of the user. The nutritional choices include a plurality of meals selected to meet a predefined nutritional goal of the user. Additionally, the one or more nutritional choices are associated with the video selection of the user and include a daily nutritional goal, a weekly nutritional goal, a monthly nutritional goal, and so forth. After compiling the nutritional choices, the nutritional choices are provided to the user. In example embodiments, the meals include composition of fats, proteins, carbohydrates, calories, and so forth selected based on nutritional values; combination of goals, results, calories burned, and calories consumed; and so forth.

In certain embodiments, the method 200 includes creating a user profile based on the user personal metrics, and generating a user health plan aimed at improving user health condition. The method 200 further includes retaining the user profile history, which can be accessed by the user to monitor his progress or to see past performance. The user profile may also store calculated data based on the user personal metrics, such as the average maximum heart rate and the like, as well as weigh-in data and other performance benchmarks tracked based on user feedback and sensor feedback. A digest of day activity, week activity, month activity, and the like can be stored in the user profile. As a variant, the users can click on a “see details” link to pop-up a detailed log of the workout session so the user can see where he was in the different zones throughout the entirety of the workout and any summary data, such as diagrams, to support the visuals. In an example embodiment, data stored in the user profile can be updated over time, by the user or based on measured user personal metrics, to enhance accuracy and performance. Monitoring and storing the user activity during the workouts, including storing data of the user personal metrics and workout video segments for each workout performed, as well as data of nutritional intake provided by the user, enables tracking of the user workout performance and nutritional intake. Furthermore, past performance can be tracked and used to optimize future workouts. Past performance shows the most effective workout video segment, the least effective workout video segment, and an advanced workout video segment. Based on the user targets, the workout video segments can be automatically filtered to remove workout video segments that are no longer effective.

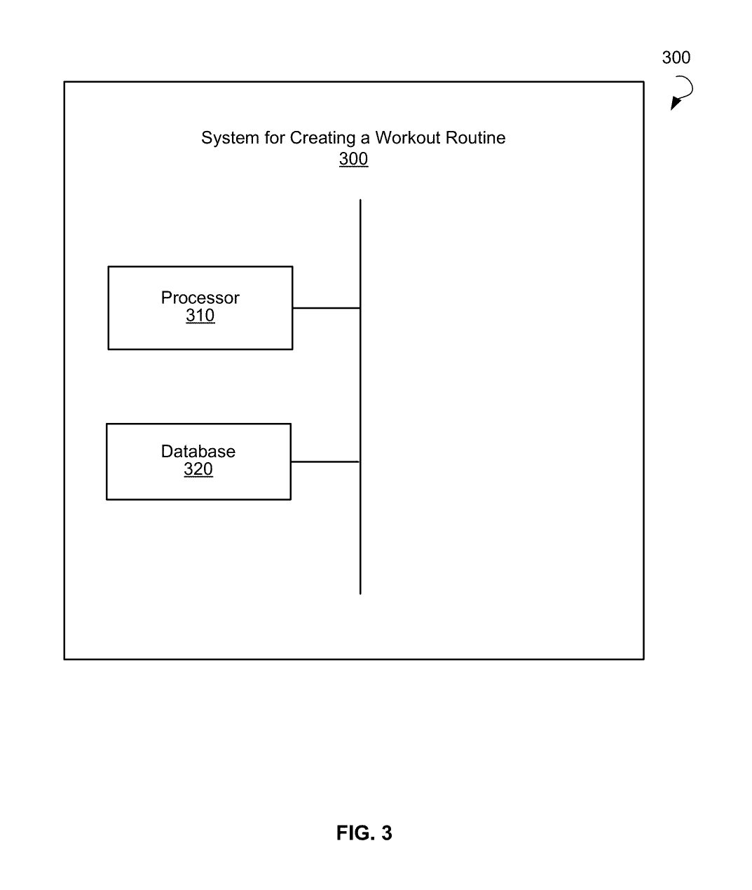

FIG. 3 is a schematic representation of components of a system for creating a workout routine, in accordance with certain embodiments. The sample system 300 comprises a processor 310. The processor 310 is configured to dynamically receive data associated with one or more user personal metrics. The user personal metrics include one or more of the following: a heart rate, a blood oxygen level, an oxygen consumption, calories burned, steps taken, distance covered, workout duration, workout intensity, a weight, a height, an age, a gender, a waist length, a fitness level, a cholesterol level, a blood pressure, a body mass index, and the like. The data associated with the one or more user personal metrics are received from one or more of a biometric sensor and a physiological sensor.

The processor 310 is further configured to provide the user with a plurality of workout video segments, based on the data associated with the one or more user personal metrics. The plurality of workout video segments can be presented to the user in a thumbnail manner allowing the user to preview exercises in each workout video segment. The processor 310 is further configured to receive, from the user, a video selection. The video selection includes one or more workout video segments selected from the plurality of workout video segments.

The processor 310 is further configured to determine that the one or more user personal metrics differ from predetermined user personal metrics. Based on the determination, the processor 310 is configured to dynamically customize the one or more workout video segments to obtain one or more customized video segments. The processor 310 is configured to dynamically overlay the data associated with the one or more user personal metrics over the one or more customized video segments. Therefore, one or more output customized video segments are obtained. The processor 310 is configured to provide the one or more output customized video segments to the user.

In certain embodiments, upon determination that the user personal metrics have changed, the processor 310 is configured to change representation of the one or more output customized video segments. Changing of representation includes color changing, size changing, changing animation, and so forth.

In certain embodiments, the processor 310 is further configured to provide an instruction to the user, based on the data associated with the one or more user personal metrics. The instruction is an indication to adjust intensity of the workout routine. The instruction can be a video instruction, an audio instruction, and a text instruction.

In certain embodiments, the processor 310 is further configured to analyze the workout routine of the user. The analysis is based on the data associated with the one or more user personal metrics. Based on the analysis, the processor 310 is operable to select a plurality of recommended workout video segments for a further workout routine.

In certain embodiments, the processor 310 is further configured to compile, based on the data associated with the user personal metrics, one or more nutritional choices and provide them to the user. The nutritional choices include a plurality of meals selected to meet a predefined nutritional goal of the user. The nutritional goal is defined by a user during registration of a user profile, or any time during the training. The nutritional goal is, for example, to loose/gain weight, lower high blood pressure, eat more vegetables, and so forth. The nutritional choices are associated with the video selection of the user. For example, if the user selects heavy exercises, the system suggests to the user to consume high-energy meals.

In certain embodiments, the processor 310 is further configured to provide the user with a meal description, a meal recipe, and a shopping list for meal ingredients. In certain embodiments, the processor 310 is further configured to provide the user with a list of restaurants and nutritional details of menu items that conform with the predefined nutritional goal of the user when the user is not eating at home.

In certain embodiments, the processor 310 is further configured to provide the user with a personalized tracker configured to assist the user with managing the workout routine and one or more nutritional choices of the user. The tracker provides users a daily/weekly/monthly view into their progress and what they need to do to keep on track. It will respond to and take feedback from their workouts and meals and provide feedback in the form of recommendations designed to assist in meeting the objectives of the user.

In certain embodiments, the processor 310 is further configured to provide the user with one or more means for a direct communication with a personal trainer, such as via email, telephone, and online chat sessions.

The system also comprises a database 320 to store personal information associated with the user. Preferably, the user information comprise user name, address, social security number, weight, eating habits, payment details, credit rating, phone number(s), e-mail addresses, personal metrics, lifestyle information, and the like. The user information can be provided by the user upon registration with the system 300 and updated by the user over time. Additionally, the system database 320 is configured to continuously collect and store wellness, workout, and nutrition result information associated with the user and store the data into a user account. The result information are provided by the user or recorded by the system after the user performs a workout routine or consume a meal.

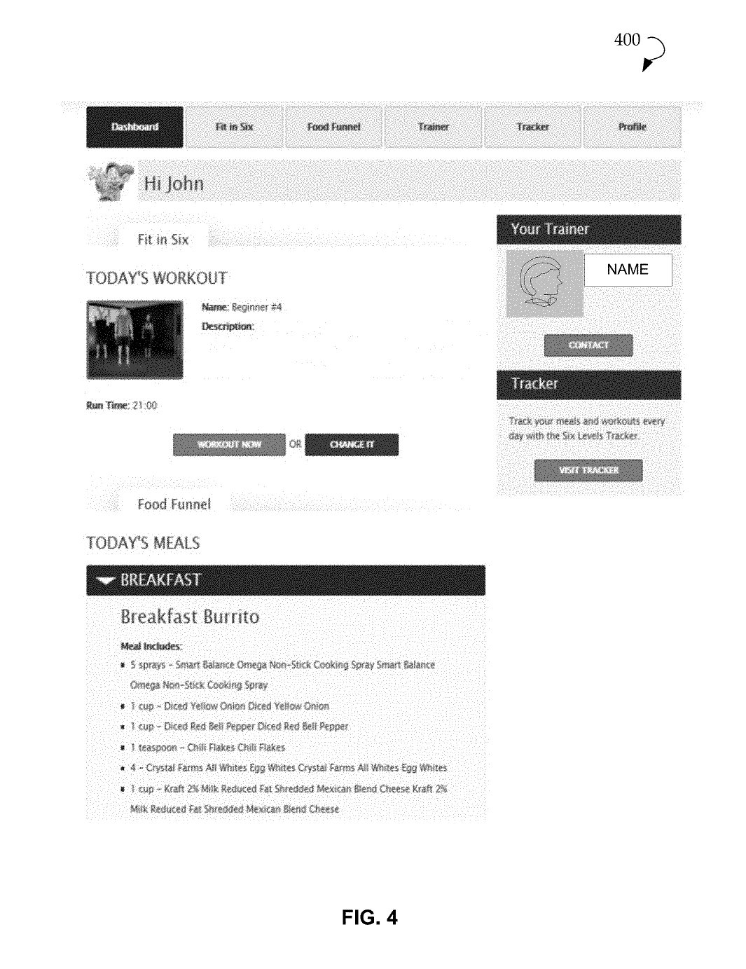

FIGS. 4-8 present exemplary presentation screens, which are generated by a server and accessed by users on a website and website pages. However, particular system and method steps are not limited to such an arrangement, as those of skill in the art will recognize that any number of different and/or additional system components, method steps, and content delivery mechanisms can also be provided without deviating from the scope and spirit of the inventive concepts disclosed herein.

In certain embodiments, the website includes a brief synopsis of information about the website such as, for example, types of exercise and dietary activities available to registered users, success stories, membership costs, and other pertinent information. Additionally, the website provides options for registering new users or for allowing previously registered members to log in. If the user has not previously registered with the system for creating a workout routine, the user is taken to a sign up page (not illustrated) where he registers to use the system for creating a workout routine. In one embodiment, the user is required to provide information such as: a username, password, and other basic information needed to establish a minimum site presence for the user. Of course, the information required to register is not limited to the above, and can include additional information such as payment information and the like.

In certain embodiments, the system for creating a workout routine provides a user profile page, which is accessible to members upon registration or login. The profile page provides users with options for managing their site presence, membership plans, and the like. Additionally, the users supply information about themselves such as their personal metrics and upload a picture or avatar, which is viewable to other site members. Although not shown, the profile page includes a link for providing updated payment information such as credit cards and the like. Upon establishing a user profile, members will have access to the rest of the system components in accordance with their membership plan.

FIG. 4 shows a sample screen of a user interface showing a user dashboard page 400, in accordance with an example embodiment. The user dashboard page 400 presents the user with daily workouts, daily meal recommendations, and information specific to the user, such as their workout tracker, and a link for contacting their personal trainer. To this end, the user dashboard page 400 is customized for each user and allows easy access for the users to the most commonly used system components.

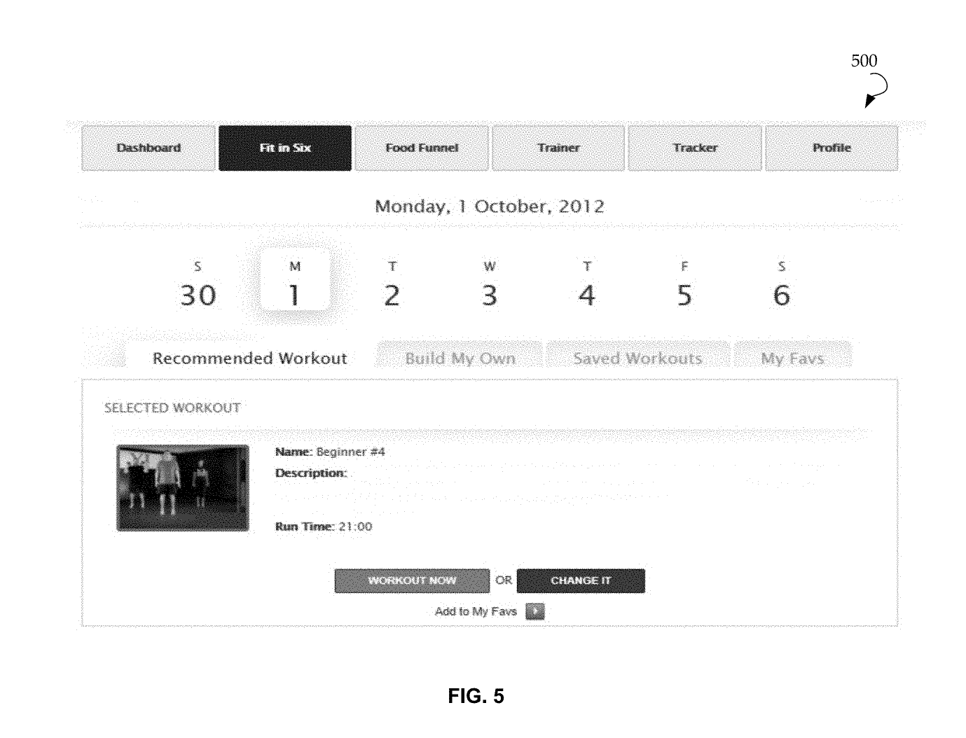

FIG. 5 shows a sample screen of a user interface showing a user workout page 500, in accordance with an example embodiment. As shown, the user workout page 500 includes a daily calendar and a plurality of options for allowing a user to choose, store, and create customized workout videos. In one embodiment, the user workout page 500 is subdivided into four separate areas entitled, for example, “recommended workout,” “build my own,” “saved workouts,” and “favorites.” The “recommended workout” section can preferably include a comprehensive and/or full body workout routine that may change each day. Information pertaining to the recommended workout can also be provided, and includes a workout name, a workout description, and the workout duration. If the users like the description of the recommended workout, they can select the recommended workout and a corresponding workout video will open in a new window.

When selected, the workout video will launch a live-action presentation featuring one or more personal trainers targeting the body areas described in the workout description. If a user does not like the recommended workout, he can change it to view a list of other comprehensive workout videos. This section includes a plurality of comprehensive workout videos that can be displayed to the user based on fitness levels, such as beginner, intermediate, and advanced, for example. Any number of additional categories and sorting schemes are also utilized.

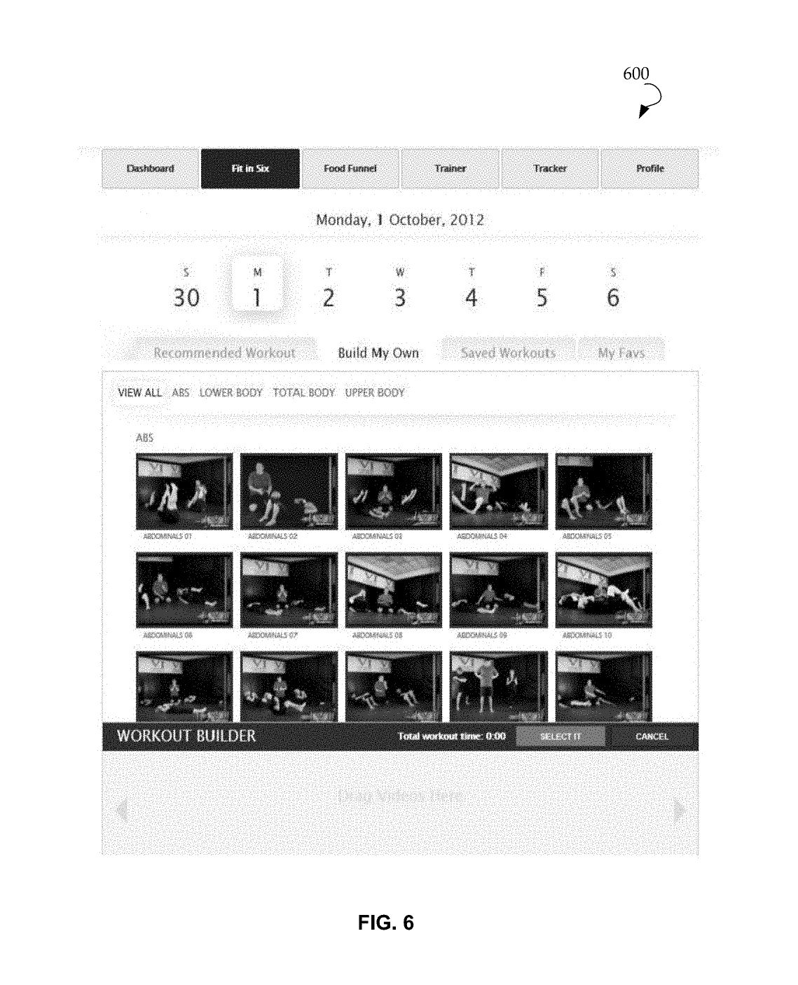

FIG. 6 shows a sample screen of a user interface showing a user customized workout page 600, in accordance with an example embodiment. The user customized workout page 600 includes a workout builder allowing site users to create a customized workout video featuring live-action presentations of one or more personal trainers targeting user-specified areas. To this end, a plurality of workout video segments is presented to a user. In this example, each video segment is approximately six minutes in length. Each of these workout video segments is grouped by particular body portions such as abs, lower body, total body, upper body, and so forth. In one embodiment, each workout video segment is presented to the user in a thumbnail manner, allowing the user to glimpse an exercise position that the video will use.

In one embodiment, the user selects one or more workout video segments and deposits the selected workout video segments into the workout builder at the bottom of the page by simply dragging and dropping the thumbnail into the workout builder. With each video added, the workout builder displays the total workout time and provides the order of the selected workout video segments. Once the user has finished selecting workout video segments, the system for creating a workout routine prompts the user for additional information such as a video name and a user supplied description. Once the information has been saved, the system for creating a workout routine automatically combines each of the user-specified workout video segments into a single video for viewing.

In certain embodiments, the system for creating a workout routine incorporates additional features into each user created video. For example, a warm up section can be included at the beginning of the video, and a series of one-minute recovery sessions can be added after each of the combined video segments. In certain embodiments, users save their customized workout videos and/or mark recommended workouts for easy retrieval at a later time.

By providing a plurality of live-action, trainer led videos which can be custom built by a user, the above described system and method can combine the motivation and benefits of attending classes at a gym with the privacy of a complete home workout.

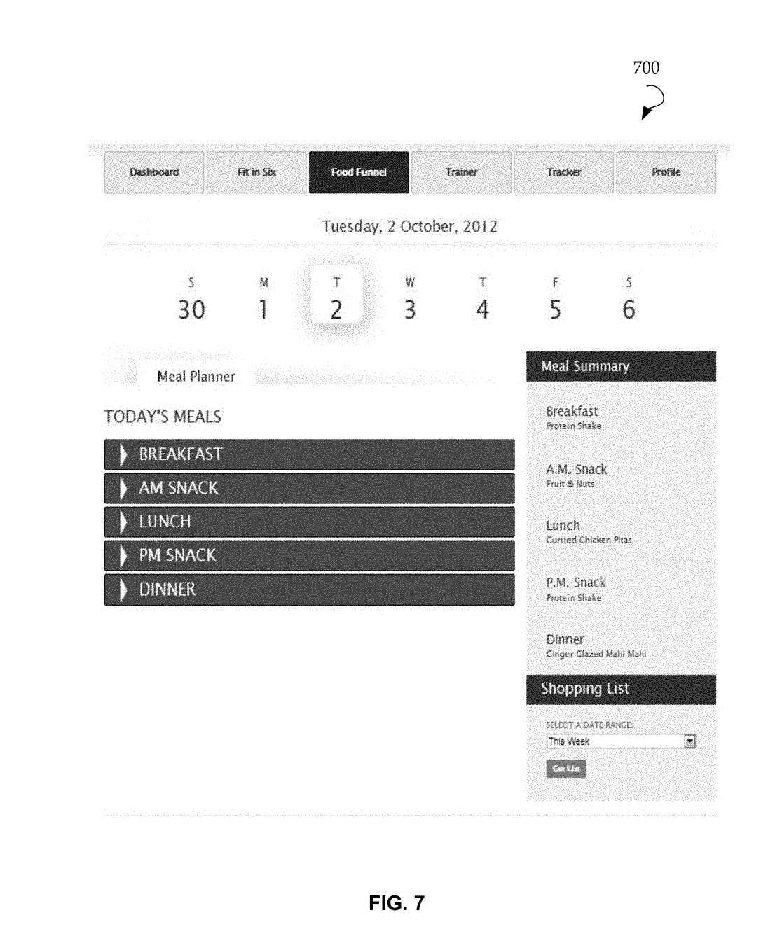

FIG. 7 shows a sample screen of a user interface showing a nutritional choice page 700, in accordance with an example embodiment. The nutritional choice page includes a daily calendar and a plurality of recommended meal options for ensuring a healthy diet that conforms to the fitness goals of the user. Each recommended meal provides the user with a complete meal description, including the recipe and a shopping list for the ingredients. Additionally, each recipe can be customized by the user. A new window containing a plurality of substitute choices is presented for the user to choose from.

In certain embodiments, the user is provided with a list of restaurants and nutritional details of several menu items, in order to provide the user with choices that conform to his fitness goals when not eating at home.

In certain embodiments, a personalized tracker is provided configured to assist users with managing workout schedules and nutritional goals. The personalized tracker provides a daily calendar charting both the meals and exercise routines of the user. In one embodiment, information from the personalized tracker is available to a personal trainer.

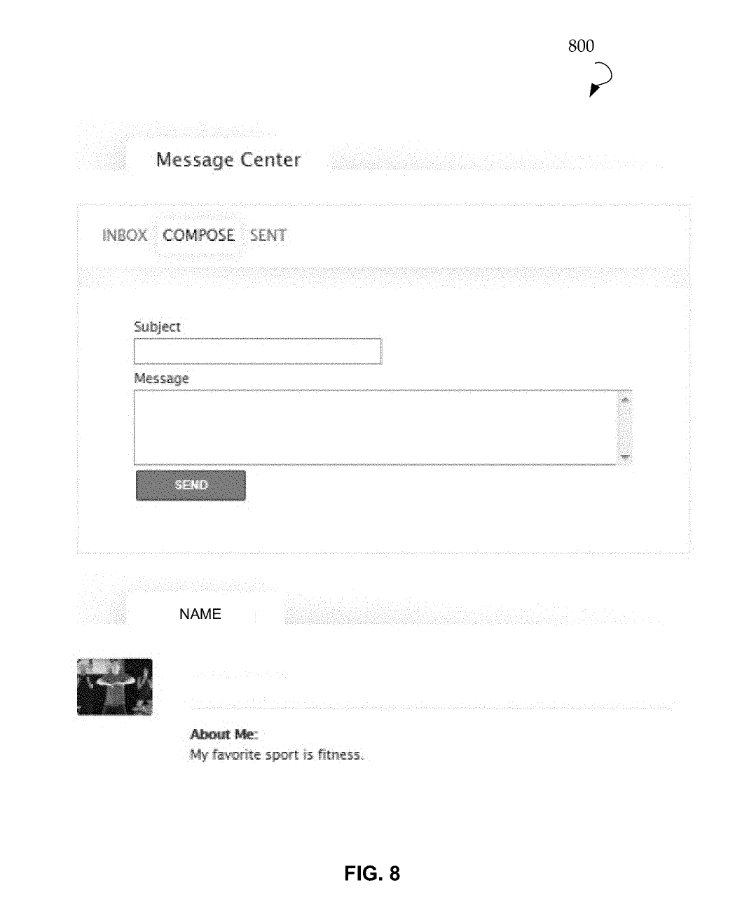

FIG. 8 shows a sample screen of a user interface showing a message center page 800, in accordance with an example embodiment. In certain embodiments, depending on a service level selected, users are able to contact a personal trainer via one or more means for a direct communication, such as email, telephone, and online chat sessions, for example. The system for creating a workout routine provides a user with information about a trainer and a message center where messages can be sent between the trainer and the user. As described above, the trainer can act as a personal coach for providing motivation to the user, and can assist the user with creating customized workout routines to achieve superior results.

In one embodiment, the system for creating a workout routine is configured to perform live video chat sessions between a user and a trainer. Such sessions are used to assist the trainer in creating a customized workout routine for the user and to establish a more personal connection. Additionally, with certain membership levels, the video chat can enable trainers to perform live one-on-one workout sessions with users via two way camera systems, which are commonly known in the art. Such feature allows users to experience a live interactive workout with a professional trainer in the privacy of their own home.

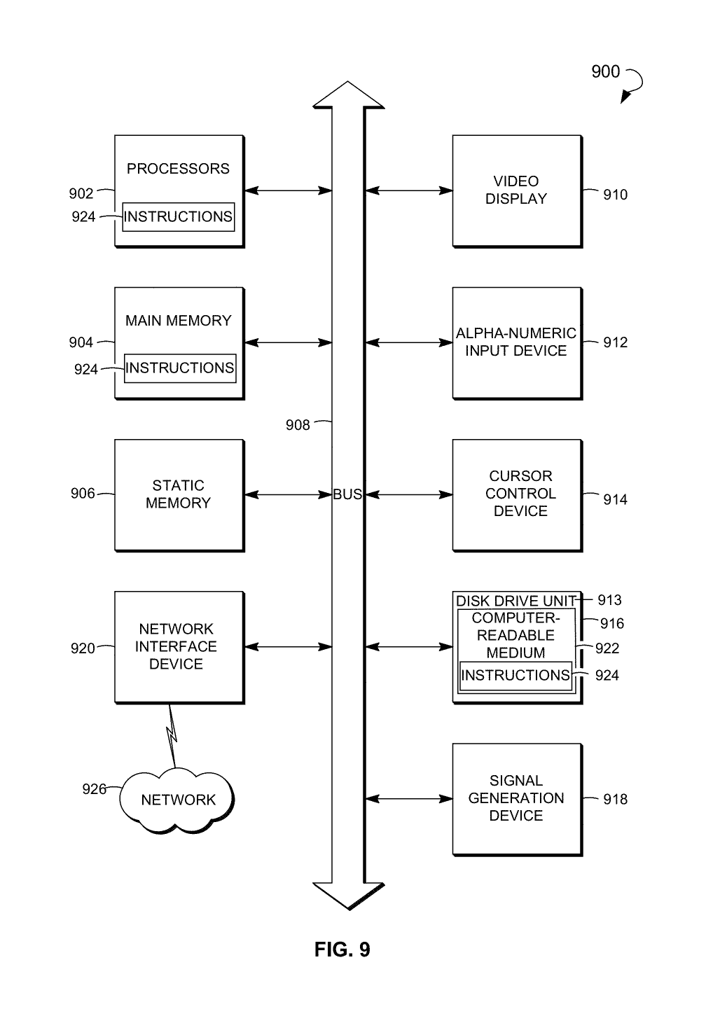

FIG. 9 shows a diagrammatic representation of a machine in the example electronic form of a computer system 900, within which a set of instructions for causing the machine to perform any one or more of the methodologies discussed herein may be executed. In various example embodiments, the machine operates as a standalone device or is connected (e.g., networked) to other machines. In a networked deployment, the machine operates in the capacity of a server or a client machine in a server-client network environment, or as a peer machine in a peer-to-peer (or distributed) network environment. The machine includes a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, smart TVs, Roku, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor or multiple processors 902 (e.g., a central processing unit (CPU), a graphics processing unit (GPU), or both), a main memory 904 and a static memory 906, which communicate with each other via a bus 908. The computer system 900 further includes a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker), and a network interface device 920.

The disk drive unit 916 includes a non-transitory computer-readable medium 922, on which is stored one or more sets of instructions and data structures (e.g., instructions 924) embodying or utilized by any one or more of the methodologies or functions described herein. The instructions 924 also reside, completely or at least partially, within the main memory 904 and/or within the processors 902 during execution thereof by the computer system 900. The main memory 904 and the processors 902 also constitute machine-readable media.

The instructions 924 are further transmitted or received over a network 926 via the network interface device 920 utilizing any one of a number of well-known transfer protocols (e.g., Hyper Text Transfer Protocol (HTTP)).

In some embodiments, the computer system 900 is implemented as a cloud-based computing environment, such as a virtual machine operating within a computing cloud. In other embodiments, the computer system 900, in turn, includes a cloud-based computing environment, where the functionalities of the computer system 900 are executed in a distributed fashion. Thus, the computer system 900, when configured as a computing cloud, includes pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources are utilized exclusively by their owners or such systems are accessible to outside users who deploy applications within the computing infrastructure to obtain the benefit of large computational or storage resources.

The cloud is formed, for example, by a network of web servers that comprise a plurality of computing devices, such as the computing device 120, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during RF and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media are involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology is written in any combination of one or more programming languages, including an object oriented programming language such as Java, Smalltalk, C++ or the like and conventional procedural programming languages, such as the “C” programming language or similar programming languages. The program code may execute entirely on the user computer, partly on the user computer, as a stand-alone software package, partly on the user computer and partly on a remote computer, or entirely on the remote computer or server. In the latter scenario, the remote computer is connected to the user computer through any type of network, including a LAN or a WAN, or the connection is made to an external computer (for example, through the Internet using an Internet Service Provider (ISP)).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions are provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions are also stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, methods and systems for creating a workout routine in online and mobile environments have been disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for creating a workout routine, the method comprising:
dynamically receiving, by a processor, data associated with one or more user personal metrics;
providing, by a processor, a user with a plurality of workout video segments based on the data associated with the one or more user personal metrics;
receiving, by the processor, from the user, a video selection, wherein the video selection includes one or more workout video segments selected from the plurality of workout video segments;
determining, by the processor, that the one or more user personal metrics differ from predetermined user personal metrics;
based on the determining, dynamically customizing, by the processor, the one or more workout video segments to obtain one or more customized video segments;
dynamically overlaying, by the processor, the data associated with the one or more user personal metrics over the one or more customized video segments to obtain one or more output customized video segments; and
providing, by the processor, the one or more output customized video segments to the user.

2. The method of claim 1, wherein the receiving of the data associated with the one or more user personal metrics includes receiving the data from one or more of a biometric sensor and a physiological sensor.

3. The method of claim 1, further comprising providing an instruction to the user based on the data associated with the one or more user personal metrics, the instruction including an indication to adjust an intensity of the workout routine.

4. The method of claim 3, wherein the instruction includes one or more of a video instruction, an audio instruction, and a text instruction.

5. The method of claim 1, further comprising:
based on the data associated with the user personal metrics, compiling, by the processor, one or more nutritional choices, wherein the one or more nutritional choices include a plurality of meals selected to meet a predefined nutritional goal of the user; and
providing, by the processor, the user with the one or more nutritional choices.

6. The method of claim 5, wherein the one or more nutritional choices include one or more of the following: a daily nutritional menu, a weekly nutritional menu, and a monthly nutritional menu.

7. The method of claim 1, further comprising changing, based on the determining, representation of the one or more output customized video segments, the changing including one or more of color changing, size changing, and animation.

8. The method of claim 1, wherein the one or more user personal metrics include one or more of the following: a heart rate, a blood oxygen level, an oxygen consumption, calories burned, steps taken, distance covered, workout duration, workout intensity, a weight, a height, an age, a gender, a waist measurement, a fitness level, a cholesterol level, a blood pressure, and a body mass index.

9. The method of claim 1, further comprising:
analyzing, based on the data associated with the one or more user personal metrics, the workout routine of the user; and
based on the analysis, selecting a plurality of recommended workout video segments for a further workout routine.

10. The method of claim 1, wherein the plurality of workout video segments are provided as thumbnails to allow the user to preview exercises in each workout video segment.

11. A system for creating a workout routine, the system comprising:
a processor operable to:
dynamically receive data associated with one or more user personal metrics;
provide a user with a plurality of workout video segments based on the data associated with the one or more user personal metrics;
receive, from the user, a video selection, wherein the video selection includes one or more workout video segments selected from the plurality of workout video segments;
determine that the one or more user personal metrics differ from predetermined user personal metrics;
based on the determining, dynamically customize the one or more workout video segments to obtain one or more customized video segments;
dynamically overlay the data associated with the one or more user personal metrics over the one or more customized video segments to obtain one or more output customized video segments; and
provide the one or more output customized video segments to the user; and
a database comprising computer-readable instructions for execution by the processor.

12. The system of claim 11, wherein the receiving of the data associated with the one or more user personal metrics includes receiving the data from one or more of a biometric sensor and a physiological sensor.

13. The system of claim 11, wherein the processor is further operable to:
provide an instruction to the user, based on the data associated with the one or more user personal metrics, the instruction including an indication to adjust an intensity of the workout routine.

14. The system of claim 13, wherein the instruction includes one or more of a video instruction, an audio instruction, and a text instruction.

15. The system of claim 11, wherein the processor is further operable to:
based on the data associated with the user personal metrics, compile one or more nutritional choices, wherein the one or more nutritional choices include a plurality of meals selected to meet a predefined nutritional goal of the user; and
provide the user with the one or more nutritional choices.

16. The system of claim 11, wherein the processor is further operable to:
change, based on the determining, representation of the one or more output customized video segments, the changing including one or more of color changing, size changing, and animation.

17. The system of claim 11, wherein the one or more user personal metrics include one or more of the following: a heart rate, a blood oxygen level, an oxygen consumption, calories burned, steps taken, distance covered, workout duration, workout intensity, a weight, a height, an age, a gender, a waist measurement, a fitness level, a cholesterol level, a blood pressure, and a body mass index.

18. The system of claim 11, wherein the processor is further operable to:
analyze, based on the data associated with the one or more user personal metrics, the workout routine of the user; and
based on the analysis, select a plurality of recommended workout video segments for a further workout routine.

19. The system of claim 11, wherein the plurality of workout video segments are provided as thumbnails to allow the user to preview exercises in each workout video segment.

20. A non-transitory processor-readable medium having instructions stored thereon, which when executed by one or more processors, cause the one or more processors to implement a method for creating a workout routine, the method comprising:
dynamically receiving, by a processor, data associated with one or more user personal metrics;
providing, by the processor, a user with a plurality of workout video segments based on the data associated with the one or more user personal metrics;
receiving, by the processor, from the user, a video selection, wherein the video selection includes one or more workout video segments selected from the plurality of workout video segments;
determining, by the processor, that the one or more user personal metrics differ from predetermined user personal metrics;
based on the determining, dynamically customizing, by the processor, the one or more workout video segments to obtain one or more customized video segments;
dynamically overlaying, by the processor, the data associated with the one or more user personal metrics over the one or more customized video segments to obtain one or more output customized video segments; and
providing, by the processor, the one or more output customized video segments to the user.
